(19) United States
(12) Patent Application Publication
(10) Pub. No.: US 2026/0171542 A1
(43) Pub. Date: Jun. 18, 2026

(54) STRUCTURAL MEMBER WITH INTEGRATED COOLING

(71) Applicant: GM GLOBAL TECHNOLOGY OPERATIONS LLC, Detroit, MI (US)

(72) Inventors: Shuonan Xu, Troy, MI (US); Xiaoling Chen, Sterling Heights, MI (US); Neeraj S. Shidore, Novi, MI (US); Lu Huang, Troy, MI (US); Jeffrey A. Abell, Rochester Hills, MI (US)

(73) Assignee: GM GLOBAL TECHNOLOGY OPERATIONS LLC, Detroit, MI (US)

(21) Appl. No.: 18/983,543

(22) Filed: Dec. 17, 2024

(51) Int. Cl. H01M 10/6557; B23K 31/02; B60K 11/02; B60L 50/60; B62D 21/03; H01M 10/613; H01M 10/615; H01M 10/625; H01M 10/647; H01M 10/6555; H01M 10/6571; H01M 50/209; H01M 50/249; H05B 3/28

(52) U.S. Cl. CPC H01M 10/6557; B23K 31/02; B60L 50/66; B62D 21/03; H01M 10/613; H01M 10/615; H01M 10/625; H01M 10/647; H01M 10/6555; H01M 10/6571; H01M 50/209; H01M 50/249; H05B 3/28; B60K 11/02; H01M 2220/20

(57) ABSTRACT

A motor vehicle includes a vehicle body structure including a vehicle frame having parallel frame rails. The motor vehicle also includes a powerplant supported by the vehicle frame and configured to generate torque and a multi-cell rechargeable energy storage system (RESS) having a plurality of battery cells configured to supply electrical energy to the powerplant. The motor vehicle additionally includes a structural member positioned perpendicular to and fixed to each of the parallel frame rails, thereby reinforcing the vehicle frame. The structural member is arranged proximate to the RESS. At least one coolant passage is arranged within the structural member and is configured to circulate coolant to adjust temperature of the plurality of battery cells.

### INTRODUCTION

The present disclosure relates to a structural member with integrated coolant passages for controlling temperature of a multi-cell rechargeable energy storage system (RESS).

Typically, an electric energy generation and storage battery system includes one or more battery cells for powering a load. A plurality of battery cells may be arranged in close proximity to one another to form a battery module or array. Batteries may be broadly classified into primary and secondary batteries.

Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Certain chemistries of rechargeable batteries, such as lithium-ion cells, exhibit high energy and power densities due to their specific electrode materials, making them capable of powering vehicles. Generally, heat-sink devices such as cold-plates with circulating coolant are employed to remove heat from batteries in the RESS.

### SUMMARY

A motor vehicle includes a vehicle body structure including a vehicle frame having parallel frame rails. The motor vehicle also includes a powerplant supported by the vehicle frame and configured to generate torque and a multi-cell rechargeable energy storage system (RESS) having a plurality of battery cells configured to supply electrical energy to the powerplant. The motor vehicle additionally includes a structural member positioned perpendicular to and fixed to each of the parallel frame rails, thereby reinforcing the vehicle frame. The structural member is arranged proximate to the RESS. At least one coolant passage is arranged within the structural member and is configured to circulate coolant to adjust temperature of the plurality of battery cells.

The structural member may be a reinforcement beam defined by beam walls, with inner surfaces of the beam walls defining an internal space. One or more of the coolant passages may be mounted within the internal space of the reinforcement beam.

The coolant passage(s) may be defined by at least one concave or curved section of rigid material fixed to the inner surface of at least one of the beam walls.

The concave section(s) of rigid material may include stamped material segments either brazed or welded to the inner surface of the beam wall(s).

The coolant passage(s) may be generated from a blow-formed bubble sheet material.

The beam may include one or more heating elements embedded within a respective one or more beam walls. The heating elements are configured to add thermal energy to the plurality of battery cells.

Each heating element may be a nichrome (NiCr) resistance wire.

The motor vehicle may also include at least one inlet fitting and at least one outlet fitting. Each coolant passage may be fluidly connected to the inlet fitting(s) and to the outlet fitting(s).

The motor vehicle may additionally include an inlet manifold configured to connect to the inlet fitting(s) and an outlet manifold configured to connect to the outlet fitting(s) such that the inlet and outlet manifolds are together configured to circulate coolant through the coolant passage(s).

Each of the plurality of battery cells may be a prismatic can cell.

The reinforcement beam may have a boxed cross-section.

A method of constructing a coolant-circulating structural member having a reinforcement beam with a boxed cross-section and at least one coolant passage, as described above, is also disclosed.

The method may include arranging within the internal space a block of rigid material defining a plurality of coolant passages.

According to the method, the boxed cross-section may be generated by welding together four side plates.

According to the method, the reinforcement beam may be generated by either roll forming or extruding the boxed cross-section.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple powerplants and a multi-cell rechargeable energy storage system (RESS) configured to generate and store electrical energy used by vehicle systems including the powerplants, and having a vehicle body structure including a vehicle frame having parallel frame rails and structural members positioned perpendicular to and fixed to the frame rails as part of a coolant system, and according to the disclosure.

FIG. 2A is a close-up schematic exploded perspective top view of the RESS shown in FIG. 1, illustrating the structural members being arranged relative to the battery cells of the RESS, according to the disclosure.

FIG. 2B is a close-up schematic perspective top view of an assembled RESS shown in FIG. 1, illustrating the structural members arranged relative to the battery cells of the RESS, according to the disclosure.

FIG. 3 is a schematic cross-sectional view of one embodiment of the structural member shown in FIGS. 2A and 2B, according to the disclosure.

FIG. 4 is a schematic cross-sectional view of another embodiment of the structural member shown in FIGS. 2A and 2B, according to the disclosure.

FIG. 5 is a close-up schematic partial top view of the RESS shown in FIG. 1, illustrating the coolant system having inlet and outlet fittings and manifolds fluidly connected to coolant passages in the structural members for circulating coolant therethrough.

FIG. 6 illustrates a method of constructing a coolant-circulating structural member shown in FIGS. 1-5.

FIG. 7 illustrates one embodiment of a process of constructing the coolant-circulating structural member, according to the method of FIG. 6.

FIG. 8 illustrates another embodiment of the process of constructing the coolant-circulating structural member, according to the method of FIG. 6.

FIG. 9 illustrates another embodiment of the process of constructing the coolant-circulating structural member, according to the method of FIG. 6.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

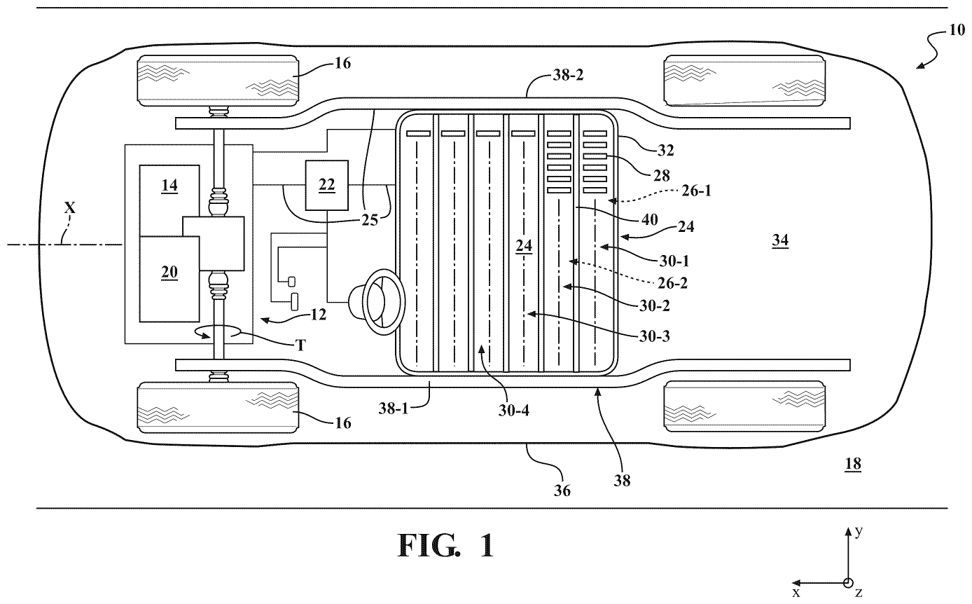

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source or powerplant 14 configured to generate a powerplant torque T (shown in FIG. 1) for propulsion of the vehicle 10 via driven wheels 16 relative to a road surface 18. The powerplant 14 is depicted as an electric motor-generator but may be configured as a fuel cell, etc.

As shown in FIG. 1, the powertrain 12 may also include an additional powerplant 20, such as an internal combustion engine. The powerplants 14 and 20 may act in concert to power the vehicle 10. The vehicle 10 additionally includes an electronic controller 22 and a multi-cell rechargeable energy storage system (RESS) 24 configured to generate and store electrical energy through heat-producing electro-chemical reactions for supplying the electrical energy to the powerplants 14 and 20. The electronic controller 22 may be a central processing unit (CPU) that regulates various functions on the vehicle 10, or as a powertrain control module (PCM) configured to control the powertrain 12 to generate a predetermined amount of powerplant torque T. The RESS 24 may be connected to the powerplants 14 and 20, the electronic controller 22, as well as other vehicle systems via a high-voltage BUS 25.

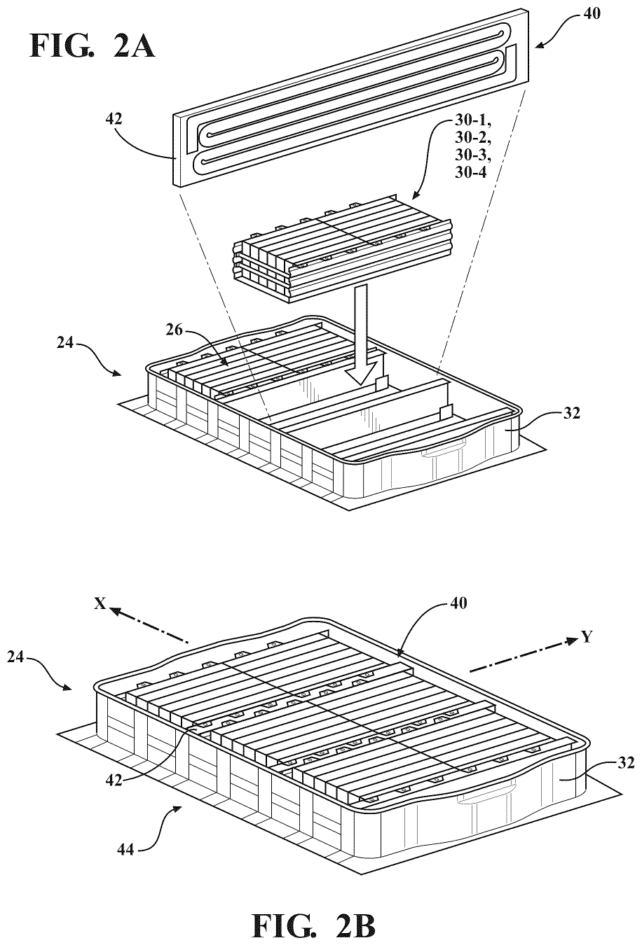

The RESS 24 includes a plurality of battery cells 28, which may be subdivided into battery groups or modules (shown as 26-1 and 26-2). The battery cells 28 may be configured as prismatic can cells. As shown in FIG. 2, the battery modules 26 of the RESS 24 may be arranged in individual rows, specifically including battery cells in a first row 30-1, a neighboring, directly adjacent, second row 30-2, as well as third and fourth rows 30-3 and 30-4. As shown, each battery cell 28 in rows 30-1, 30-2, 30-3, 30-4 etc. may be configured as a prismatic can cell or a cylindrical cell extending generally upward or in Z direction. Although two modules, 26-1 and 26-2, with four rows 30-1, 30-2, 30-3, 30-4 of battery cells 28 in each module are shown, nothing precludes the RESS 24 from having a greater or fewer number of such modules and rows.

The remainder of the present description will focus on module construction having four rows 30-1, 30-2, 30-3, 30-4 of battery cells 28, which may be adapted to a specific battery module having a desired overall quantity of cells. As shown in FIG. 1, the RESS 24 also includes a battery pack enclosure 32 surrounded by an ambient environment 34. The battery pack enclosure 32 is configured to house each row 30-1, 30-2, 30-3, 30-4 of the battery cells 28 in respective modules, e.g., 26-1 and 26-2, and may include an enclosure lower portion or a tray and an upper portion or a cover (not shown).

With continued reference to FIG. 1, motor vehicle 10 houses the above-described powertrain 12, associated systems, and the RESS 24 in a vehicle body structure 36. As shown, body structure 36 includes a vehicle frame 38 arranged generally in X-Y plane and configured to support the powerplants 14, 20 and other vehicle systems. The vehicle frame 38 includes parallel frame rails 38-1 and 38-2 extending along X-axis, i.e., along the length of the vehicle 10. Body structure 36 also includes one or more structural members 40 positioned perpendicular to and fixed (such as bolted, welded, etc.) to each of the parallel frame rails 38-1, 38-2. As shown in FIGS. 2A and 2B, each structural member 40 may be based on a reinforcement beam 42 arranged to strengthen the vehicle frame 38. As shown, each of the structural members 40 is arranged proximate to the RESS 24.

With reference to FIGS. 2A and 2B, the battery pack enclosure 32 may be shaped to accommodate the structural members 40 and allow the subject structural members to extend alongside each corresponding row 30-1, 30-2, 30-3, 30-4 of battery cells 28 or position a number of subject rows between each pair of structural members. The battery pack enclosure 32 may also facilitate connection and fastening of the structural members 40 to the frame 38, such as through respective locating features and/or apertures (not shown). For example, the battery pack enclosure 32 may include channels formed and positioned such that each row 30-1, 30-2, 30-3, 30-4 has at least one structural member arranged along its side. In addition to reinforcing the body structure 36, structural members 40 are configured to be part of a coolant system 44 designed to regulate temperature of the RESS 24. The coolant system 44 may be used to remove thermal energy from or add thermal energy to the plurality of battery cells 28 as necessitated by the operating conditions of RESS 24. As a result, each of the structural members 40 serves as a coolant-circulating reinforcement of the vehicle body structure 36.

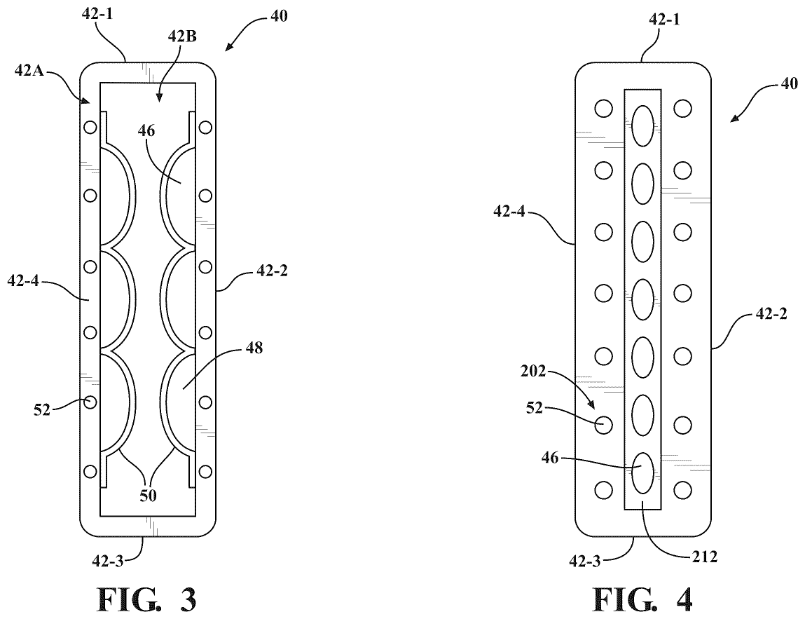

As shown in FIG. 3, each of the structural members 40 includes or is based on the reinforcement beam 42 which may have a boxed cross-section 42A. At least one coolant passage 46 is integrally arranged within each structural member 40. Each coolant passage 46 is configured to circulate coolant 48 therethrough to adjust temperature of the plurality of battery cells 28, e.g., remove thermal energy therefrom or heat the cells when required. The coolant passages 46 may therefore be configured to remove thermal energy from or add thermal energy directly to the side walls of prismatic can cells 28. Each structural member 40 may be defined by beam walls 42-1, 42-2, 42-3, and 42-4, having a thickness t with inner surfaces of the respective walls defining an internal space 42B. The coolant passage(s) 46 may be constructed using various methods (to be described in detail below) and be mounted within the internal space 42B of the reinforcement beam. As shown, coolant passage(s) 46 are specifically configured to thermally affect the beam walls 42-2 and 42-4 that are adjacent respective battery rows in RESS 24.

Each coolant passage 46 may be defined by at least one concave or curved section 50 of rigid material fixed to the inner surface of at least one of the beam walls 42-1, 42-2, 42-3, 42-4. Multiple curved sections 50 of rigid material, e.g., steel or aluminum stamped segments, may be used and either brazed or welded to the inner surface of one or more of the beam walls 42-1, 42-2, 42-3, 42-4. Alternatively, the curved section(s) 50 of coolant passage(s) 46 may be generated using a blow-formed bubble metal sheet material. Each structural member 40 may additionally include one or more heating elements 52 embedded within a respective at least one of the beam walls 42-2 and 42-4, as may be seen in a cross-sectional view of the beam shown in FIG. 4 to thermally affect adjacent battery rows of RESS 24.

The heating element(s) 52 are intended to add thermal energy to proximately positioned battery cells 28 as required, for example at cold start of the powerplants 14, 20. Each heating element may be a nichrome or nickel-chromium (NiCr) resistance wire. In another embodiment, such heating elements 52 may be arranged in alternating order with coolant passages 46 (not shown) in the respective beam walls 42-2 and 42-4. The heating element(s) 52 may also be configured as a sheath (not shown) embedded in the respective walls 42-2, 42-4. Each pair of neighboring structural members 40, may be in contact with and sandwich one corresponding row 30-1, 30-2, 30-3, 30-4 and thereby configured to absorb and remove thermal energy therefrom or add thermal energy thereto.

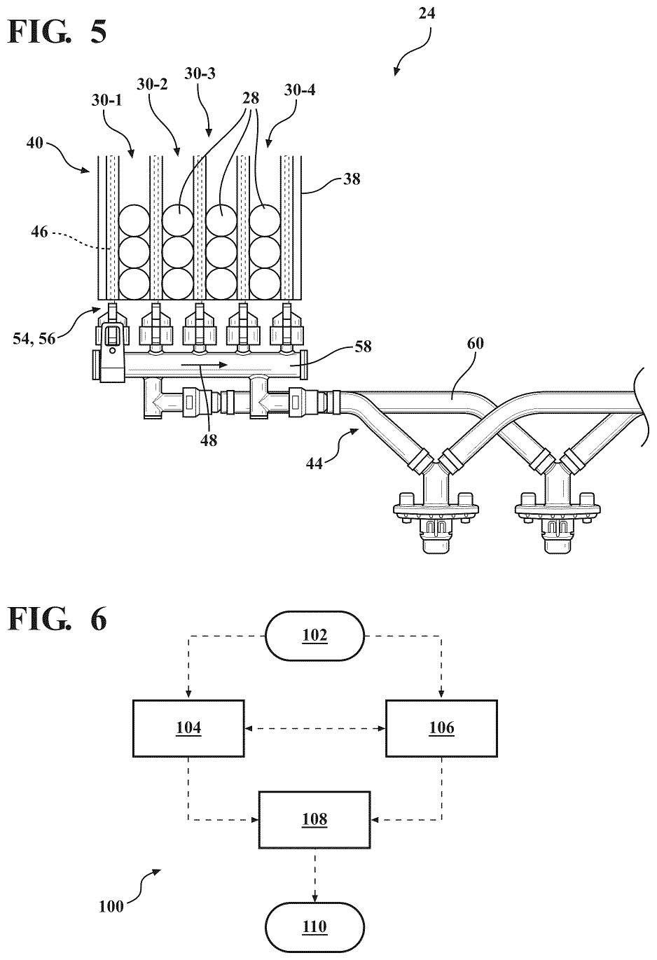

With reference to FIG. 5, the coolant system 44 may also include coolant inlet fittings 54 and coolant outlet fittings 56. Each of the inlet fittings 54 and outlet fittings 56 is fluidly connected to coolant passage(s) 46 in a corresponding structural member 40 for circulating the coolant 48 therethrough. The coolant system 44 may further include a respective inlet manifold 58 and a respective outlet manifold 60, which, as shown in FIG. 5, are fluidly connected to corresponding inlet fittings 54 and outlet fittings 56. Together, the inlet and outlet manifolds 58, 60 are configured to circulate coolant 48 through the coolant passage(s) 46 of structural member(s) 40. Each of the inlet and outlet manifolds 58, 60 may have a respective fluid connection to an external source of the coolant 48, such as a fluid pump (not shown).

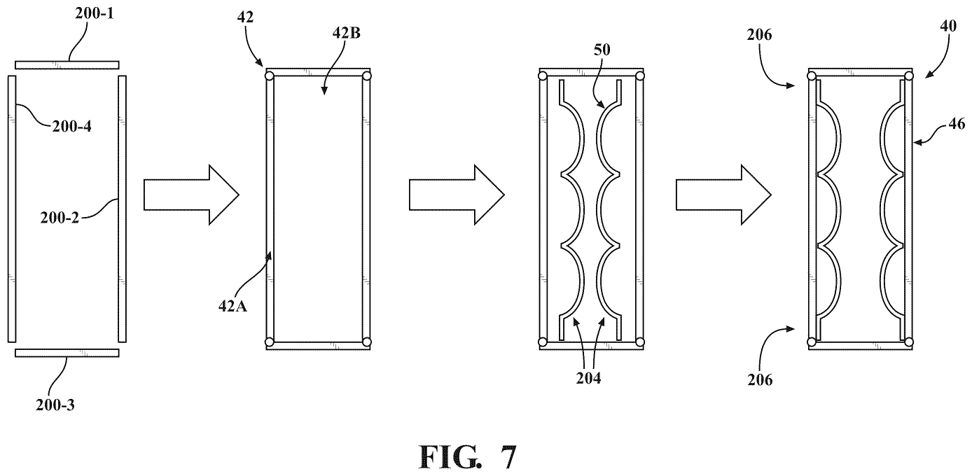

A method 100 of constructing the structural member 40 configured to circulate a coolant and adjust temperature of battery cells 28 in the multi-cell rechargeable energy storage system (RESS) 24, is shown in FIG. 6 and described below with reference to the structure shown in FIGS. 1-5 and particular embodiments of a manufacturing process shown in FIGS. 7-9 Method 100 commences in frame 102 with generating the reinforcement beam 42 having the boxed cross-section 42A defined by the beam walls 42-1, 42-2, 42-3, 42-4. As described above with respect to FIGS. 1-5, inner surfaces of the beam walls 42-1, 42-2, 42-3, 42-4 may define the internal space 42B. Specifically, as shown in FIG. 7, boxed cross-section 42A may be generated by welding together four side plates 200-1, 200-2, 200-3, and 200-4, thus forming the respective beam walls 42-1, 42-2, 42-3, 42-4. Alternatively, boxed cross-section 42A may be generated by either roll forming or extruding.

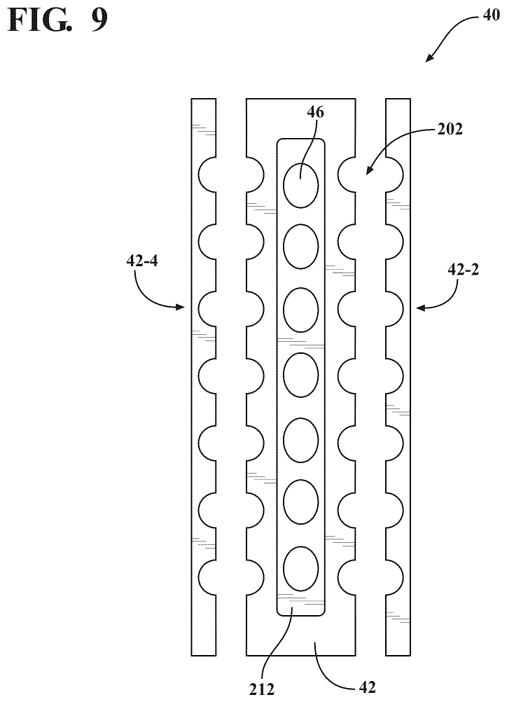

From frame 102, the method advances to either frame 104 or frame 106. In frame 104, the method includes embedding at least one heating element 52 within respective beam walls 42-1, 42-2, 42-3, 42-4. As described above with respect to FIGS. 3 and 4, each heating element 52 may thus be used to add thermal energy to proximately positioned battery cells 28 of the RESS 24. Each heating element 52 may be a nichrome (NiCr) resistance wire. The heating element(s) 52 may be inserted through preformed passages 202 (shown in FIG. 4) in at least one of the beam walls 42-1, 42-2, 42-3, 42-4. Alternatively, as shown in FIG. 9, passages 202 (and/or coolant passages 46) may be constructed from machined or formed half-channels in subsequently assembled portions of the beam walls 42-2 and 42-4. In a constructed structural member 40, the heating elements 52. may conduct thermal energy to the corresponding beam walls 42-1, 42-2, 42-3, 42-4 and radiate the energy through exterior surfaces of the subject walls to the battery cells 28.

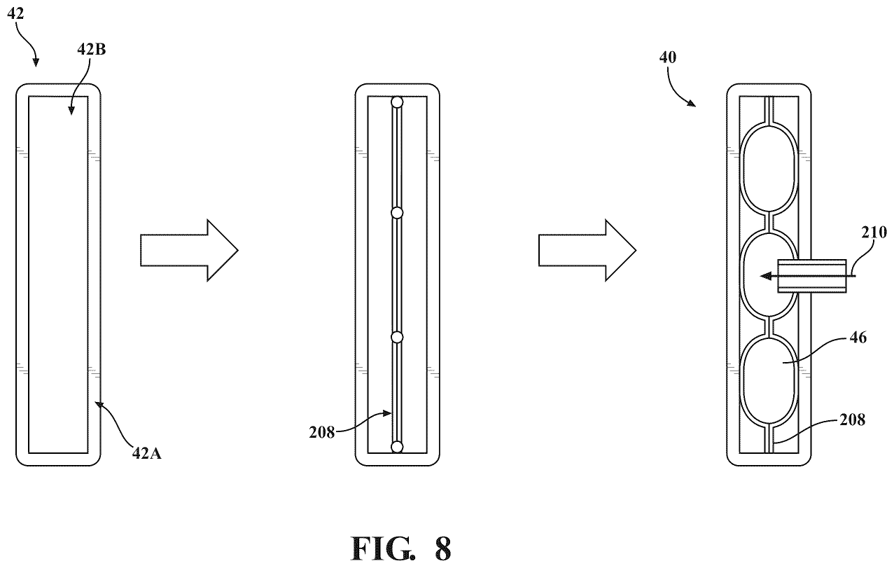

In frame 106, the method includes arranging at least one coolant passage 46 within the internal space 42B with each coolant passage being configured to circulate the coolant 48 therethrough. The coolant passage(s) 46 may be arranged by fixing at least one concave section 50 of rigid material to the inner surfaces of beam walls 42-1, 42-2, 42-3, 42-4. The concave sections 50 may be formed from multiple stamped material segments, as shown in FIG. 9. The stamped material segments 204 may be fixed to the inner surface of the beam walls by brazing or welding 206 (shown in FIG. 7). Alternatively, as shown in FIG. 8, the coolant passage(s) 46 may be arranged within the structural member 40 by blow-forming 208 the coolant passage(s) 46 from a bubble sheet material 210. In another alternative, the coolant passage(s) 46 may be arranged within structural member 40 by inserting a block 212 (shown in FIGS. 4 and 9) of rigid material, e.g., steel or aluminum, that defines the coolant passage(s). As noted above, the coolant passage(s) 46 may also be constructed from machined or formed half-channels.

Following either of the frames 104 or 106, the method may proceed to frame 108 for completion of the structural member 40, e.g., welding one of mounting brackets (not shown), etc., or conclude in frame 110. Overall, method 100 is intended to generate the structural member 40 capable of being used to adjust temperature of battery cells in a RESS using coolant passages to route relatively low or relatively high temperature coolant. Additionally, method 100 may include embedding heating elements within the structural member 40 to provide the member with further ability to adjust temperature of the battery cells.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A motor vehicle comprising:
a vehicle body structure including a vehicle frame having parallel frame rails;
a powerplant supported by the vehicle frame and configured to generate torque;
a multi-cell rechargeable energy storage system (RESS) having a plurality of battery cells configured to supply electrical energy to the powerplant;
a structural member positioned perpendicular to and fixed to each of the parallel frame rails, thereby reinforcing the vehicle frame, and arranged proximate to the RESS; and
at least one coolant passage arranged within the structural member and configured to circulate coolant to adjust temperature of the plurality of battery cells.

2. The motor vehicle of claim 1, wherein the structural member is a reinforcement beam defined by beam walls, with inner surfaces of the beam walls defining an internal space, and wherein the at least one coolant passage is mounted within the internal space of the reinforcement beam.

3. The motor vehicle of claim 2, wherein the at least one coolant passage is defined by at least one concave section of rigid material fixed to the inner surface of at least one of the beam walls.

4. The motor vehicle of claim 3, wherein the at least one concave section of rigid material includes multiple stamped material segments one of brazed and welded to the inner surface of the at least one of the beam walls.

5. The motor vehicle of claim 2, wherein the at least one coolant passage is generated using a blow-formed bubble sheet material.

6. The motor vehicle of claim 2, further comprising at least one heating element embedded within a respective at least one of the beam walls and configured to add thermal energy to the plurality of battery cells.

7. The motor vehicle of claim 6, wherein each heating element is a nichrome (NiCr) resistance wire.

8. The motor vehicle of claim 1, further comprising at least one inlet fitting and at least one outlet fitting, wherein each coolant passage is fluidly connected to the at least one inlet fitting and to the at least one outlet fitting.

9. The motor vehicle of claim 8, further comprising an inlet manifold configured to connect to the at least one inlet fitting and an outlet manifold configured to connect to the at least one outlet fitting such that the inlet and outlet manifolds are together configured to circulate coolant through the at least one coolant passage.

10. The motor vehicle of claim 1, wherein each of the plurality of battery cells is a prismatic can cell.

11. A method of constructing a coolant circulating structural member, the method including:
generating a reinforcement beam having a boxed cross-section defined by beam walls, wherein inner surfaces of the beam walls define an internal space;
arranging at least one coolant passage within the internal space of the reinforcement beam, and wherein each coolant passage is configured to circulate the coolant therethrough.

12. The method of claim 11, wherein arranging at least one coolant passage within the reinforcement beam includes fixing at least one concave section of rigid material to the inner surface of at least one of the beam walls.

13. The method of claim 12, wherein the at least one concave section of rigid material includes multiple stamped material segments, and wherein fixing the multiple stamped material segments includes one of brazing and welding the stamped material segments to the inner surface of the at least one of the beam walls.

14. The method of claim 11, wherein arranging at least one coolant passage within the structural member includes generating the at least one coolant passage from a blow-formed bubble sheet material.

15. The method of claim 11, further comprising embedding at least one heating element within a respective at least one of the beam walls.

16. The method of claim 15, wherein each heating element is a nichrome (NiCr) resistance wire.

17. The method of claim 11, wherein arranging at least one coolant passage within the internal space includes inserting a block of rigid material defining a plurality of coolant passages.

18. The method of claim 11, wherein generating the boxed cross-section includes welding together four side plates.

19. The method of claim 11, wherein generating the reinforcement beam includes one of roll forming and extruding the boxed cross-section.

20. A motor vehicle comprising:
a vehicle body structure including a vehicle frame having parallel frame rails;
a powerplant supported by the vehicle frame and configured to generate torque;
a multi-cell rechargeable energy storage system (RESS) having a plurality of battery cells configured to supply electrical energy to the powerplant;
a structural member positioned perpendicular to and fixed to each of the parallel frame rails, thereby reinforcing the vehicle frame, and arranged proximate to the RESS, wherein the structural member is a reinforcement beam defined by beam walls, with inner surfaces of the beam walls defining an internal space;
at least one coolant passage arranged within the structural member and configured to circulate coolant to adjust temperature of the plurality of battery cells, wherein the at least one coolant passage is mounted within the internal space of the reinforcement beam; and
at least one heating element embedded within a respective at least one of the beam walls and configured to add thermal energy to the plurality of battery cells.
